(19) United States
(12) Patent Application Publication
(10) Pub. No.: US 2025/0101986 A1
(43) Pub. Date: Mar. 27, 2025

(54) CONTAINER, CONTAINER SYSTEM, MAINTENANCE SYSTEM, AND MAINTENANCE METHOD FOR LIQUID HYDROGEN PUMP

(71) Applicant: EBARA CORPORATION, Tokyo (JP)

(72) Inventors: Tetsuji KASATANI, Tokyo (JP); Katsuyuki TAKANO, Tokyo (JP); Mitsutaka IWAMI, Tokyo (JP); Shuichiro HONDA, Tokyo (JP); Kei WATAJI, Tokyo (JP); Asaki SUZUKI, Tokyo (JP)

(21) Appl. No.: 18/727,741

(22) PCT Filed: Jan. 10, 2023
(86) PCT No.: PCT/JP2023/000262

§ 371 Date: Jul. 10, 2024

(30) Foreign Application Priority Data
Jan. 11, 2022 (JP) 2022-002439

(51) Int. Cl. F04D 7/00

(52) U.S. Cl. CPC F04D 7/00; F05D 2230/72; F05D 2260/02

(57) ABSTRACT

Provided is a container capable of raising a temperature of a liquid hydrogen pump during maintenance and a system including such a container. Provided is a maintenance system used for maintenance of a liquid hydrogen pump, the maintenance system including: a hollow container main body that allows a liquid hydrogen pump to pass through during maintenance, the container main body having one or more inlets and one outlet; a circulation flow path that connects the outlet and the one or more inlets; a blower that is provided on the circulation flow path and guides helium gas from the outlet to the one or more inlets to circulate the helium gas in the circulation flow path; and a heat exchanger that raises a temperature of the helium gas passing through the circulation flow path by atmosphere.

### TECHNICAL FIELD

The present invention relates to a container, a container system, a maintenance system, and a maintenance method for a liquid hydrogen pump.

### BACKGROUND ART

When a liquefied natural gas (LNG) pump is maintained, a temperature of the LNG pump is raised to a safe temperature using nitrogen in order to safely perform the maintenance work. Since a liquid temperature of LNG is about −162 degrees, which is higher than a boiling point of nitrogen (−196 degrees), the temperature rise using nitrogen is effective.

On the other hand, when a liquid hydrogen pump is maintained, it is also desirable to similarly raise a temperature of the liquid hydrogen pump. However, a liquid temperature of liquid hydrogen is about −253 degrees, which is lower than the boiling point of nitrogen. Therefore, the temperature rise using nitrogen is difficult.

### CITATION LIST

### Patent Literature

Patent Literature 1: JP 2018-80801 A

### SUMMARY OF INVENTION

### Technical Problem

An object of the present invention is to provide a container, a container system, and a maintenance system capable of raising a temperature of a liquid hydrogen pump during maintenance. Another object of the present invention is to provide a safe maintenance method for a liquid hydrogen pump.

### Solution to Problem

[1]
   According to one embodiment, provided is a maintenance system used for maintenance of a liquid hydrogen pump, the maintenance system comprising:
   a hollow container main body that allows a liquid hydrogen pump to pass through during maintenance, the container main body having one or more inlets and one outlet;
   a circulation flow path that connects the outlet and the one or more inlets;
   a blower that is provided on the circulation flow path and guides helium gas from the outlet to the one or more inlets to circulate the helium gas in the circulation flow path; and
   a heat exchanger that raises a temperature of the helium gas passing through the circulation flow path by atmosphere.
[2] The maintenance system according to [1] may further comprise a fan that blows air to the heat exchanger.
[3] According to one embodiment, provided is a maintenance system used for maintenance of a liquid hydrogen pump, the maintenance system comprising:
   a hollow container main body that allows a liquid hydrogen pump to pass through during maintenance, the container main body having one or more inlets and one outlet;
   a circulation flow path that connects the outlet and the one or more inlets;
   a blower that is provided on the circulation flow path and guides helium gas from the outlet to the one or more inlets to circulate the helium gas in the circulation flow path; and
   an electric heater that raises a temperature of the helium gas passing through the circulation flow path.
[4] The maintenance system according to [3], the electric heater may be provided around a pipe constituting the circulation flow path and is not in contact with helium gas.
[5] The maintenance system according to [3] or [4] may further comprise:
   a first temperature sensor that is provided in the circulation flow path and measures a first temperature of helium gas to the container main body;
   a second temperature sensor that is provided in the circulation flow path and measures a second temperature of helium gas from the container main body; and
   a controller that controls temperature rise by the electric heater based on the first temperature and the second temperature.
[6] The maintenance system according to [5], wherein the controller may control the temperature rise by the electric heater such that a difference between the first temperature and the second temperature becomes constant.
[7] The maintenance system according to one of [3] to [6] may further comprise:
   a first temperature sensor that is provided in the circulation flow path and measures a first temperature of helium gas to the container main body;
   a second temperature sensor that is provided in the circulation flow path and measures a second temperature of helium gas from the container main body; and
   a controller that controls a flow rate of helium gas generated by the blower based on the first temperature and the second temperature.
[8] The maintenance system according to [7], wherein the controller may control the flow rate of helium gas by the blower based on a difference between the first temperature and the second temperature such that an amount of heat given by helium gas to the liquid hydrogen pump becomes constant.
[9] The maintenance system according to one of [3] to [8] may further comprises:
   a third sensor that measures a third temperature of the electric heater; and
   a controller that controls temperature rise by the electric heater based on the third temperature.
[10] According to one embodiment, provides is a maintenance system used for maintenance of a liquid hydrogen pump, the maintenance system comprising:
   a hollow container main body that allows a liquid hydrogen pump to pass through during maintenance, the container main body having one or more inlets and one outlet;
   a circulation flow path that connects the outlet and the one or more inlets;
   a blower that is provided on the circulation flow path and guides helium gas from the outlet to the one or more inlets to circulate the helium gas in the circulation flow path;
   a heat exchanger that raises a temperature of the helium gas passing through the circulation flow path by steam;
   a steam pipe that is provided on an inner surface of the container main body and through which steam passes; and
   a steam generation device that supplies steam to the heat exchanger and the steam pipe.
[11] The maintenance system according to [10] may further comprise:
   a first pipe that connects a steam outlet of the steam generation device and a steam inlet of the heat exchanger;
   a second pipe that connects a steam outlet of the heat exchanger and a steam inlet of the steam pipe; and
   a third pipe that connects a steam outlet of the steam pipe and a steam inlet of the steam generation device.
[12] The maintenance system according to [10] or [11] may further comprise:
   a first temperature sensor that is provided in the circulation flow path and measures a first temperature of helium gas to the container main body;
   a second temperature sensor that is provided in the circulation flow path and measures a second temperature of helium gas from the container main body; and
   a controller that controls supply of steam from the steam generation device based on the first temperature and the second temperature.
[13] The maintenance system according to [12], wherein the controller may control a flow rate of the steam from the steam generation device based on a difference between the first temperature and the second temperature such that an amount of heat given to the liquid hydrogen pump by helium gas is constant.
[14] The maintenance system according to one of [10] to [13] may further comprising:
   a first temperature sensor that is provided in the circulation flow path and measures a first temperature of helium gas to the container main body;
   a second temperature sensor that is provided in the circulation flow path and measures a second temperature of helium gas from the container main body; and
   a controller that controls a flow rate of helium gas generated by the blower based on the first temperature and the second temperature.
[15] The maintenance system according to [14], wherein the controller may control a flow rate of the helium gas by the blower based on a difference between the first temperature and the second temperature such that an amount of heat given to the liquid hydrogen pump by helium gas becomes constant.
[16] The maintenance system according to any one of [1], [3], and [10], wherein the one or more inlets may include at least a first inlet and a second inlet.
[17] The maintenance system according to [16], wherein
   helium gas from the first inlet may be directly blown to a first portion of the liquid hydrogen pump, and
   helium gas from the second inlet may be directly blown to a second portion of the liquid hydrogen pump different from the first portion.
[18] According to one embodiment, provides is a maintenance method for a liquid hydrogen pump, comprising:
   a step of installing a container including a hollow container main body having one or more inlets and one outlet on an upper portion of a hollow column provided around the liquid hydrogen pump;
   a step of raising a temperature of the liquid hydrogen pump in the container main body by circulating helium gas in a circulation flow path connecting the outlet and the one or more inlets and the container main body while pulling up the liquid hydrogen pump in the container; and
   a step of raising, by a heat exchanger, a temperature of the helium gas passing through the circulation flow path by atmosphere.
[19] According to one embodiment, provides is a maintenance method for a liquid hydrogen pump, comprising:
   a step of installing a container including a hollow container main body having one or more inlets and one outlet on an upper portion of a hollow column provided around the liquid hydrogen pump;
   a step of raising a temperature of the liquid hydrogen pump in the container main body by circulating helium gas in a circulation flow path connecting the outlet and the one or more inlets and the container main body while pulling up the liquid hydrogen pump in the container; and
   a step of raising, by an electric heater, a temperature of the helium gas passing through the circulation flow path.
[20] According to one embodiment, provides is a maintenance method for a liquid hydrogen pump, comprising:
   a step of installing a container including a hollow container main body having one or more inlets and one outlet and provided with a steam pipe on an inner surface, on an upper portion of a hollow column provided around the liquid hydrogen pump;
   a step of raising a temperature of the liquid hydrogen pump in the container main body by circulating helium gas in a circulation flow path connecting the outlet and the one or more inlets and the container main body, and allowing steam from a steam generation device to pass through the steam pipe while pulling up the liquid hydrogen pump in the container; and
   a step of, by a heat exchanger, raising a temperature of the helium gas passing through the circulation flow path by the steam from the steam generation device.
[21] According to one embodiment, provides is a container used for maintenance of a liquid hydrogen pump, the container comprising:
   a hollow container main body that allows a liquid hydrogen pump to pass through during maintenance; and
   a heater provided on an inner surface of the container main body.
[22] The container according to [21], wherein the heater may be a far-infrared ceramic heater.
[23] According to one embodiment, provides is a container used for maintenance of a liquid hydrogen pump, the container comprising:
   a hollow container main body that allows a liquid hydrogen pump to pass through during maintenance; and
   a pipe that is provided on an inner surface of the container main body and through which steam passes.
[24] The container according to [23], wherein a coating material that promotes radiation of far infrared rays may be applied to an outer surface of the pipe.
[25] The container according to any one of [21] to [24], wherein the container main body may be provided with a pipe used for purging helium gas.
[26] According to one embodiment, provides is a container system comprising:
   a liquid hydrogen pump;
   a hollow column provided around the liquid hydrogen pump; and
   the container according to [21 or 23 installed on an upper portion of the hollow column.
[27] According to one embodiment, provides is a maintenance method for a liquid hydrogen pump, comprising:
   a step of installing a hollow container provided with a heater on an inner surface, on an upper portion of a hollow column provided around the liquid hydrogen pump; and
   a step of pulling up the liquid hydrogen pump in the container and raising a temperature of the liquid hydrogen pump by the heater.
[28] According to one embodiment, provides is a maintenance method for a liquid hydrogen pump, comprising:
   a step of installing a hollow container provided with a pipe through which steam passes on an inner surface, on an upper portion of a hollow column provided around the liquid hydrogen pump; and
   a step of pulling up the liquid hydrogen pump in the container and raising a temperature of the liquid hydrogen pump by far infrared rays caused by the steam.
[29] The maintenance method for a liquid hydrogen pump according to [27] or [28], further comprising a step of purging helium gas inside the container.
[30] The maintenance method for a liquid hydrogen pump according to [27] or [28], further comprising a step of further raising the temperature of the liquid hydrogen pump, which has been raised, using nitrogen.

### Advantageous Effects of Invention

A temperature of a liquid hydrogen pump can be raised during maintenance. In addition, the liquid hydrogen pump can be safely maintained.

### BRIEF DESCRIPTION OF DRAWINGS

FIG. 1A is a partial perspective view of a container system 1 according to a first embodiment.

FIG. 1B is a schematic vertical cross-sectional view of the container system 1 according to the first embodiment.

FIG. 2A is a transparent perspective view of a purge container 13 in a container 20 according to the first embodiment.

FIG. 2B is a front view of one inner surface 13a of the purge container 13.

FIG. 2C is a vertical cross section passing through centers of inner surfaces 13a and 13b in the purge container 13.

FIG. 3A is a transparent perspective view of a purge container 13 in a container 20 according to a second embodiment.

FIG. 3B is a front view of an inner surface 13a of the purge container 13.

FIG. 3C is a vertical cross-sectional view passing through centers of the inner surfaces 13a and 13b in the purge container 13.

FIG. 4A is a schematic configuration view of a maintenance system 100 according to a third embodiment.

FIG. 4B is a schematic configuration view of a maintenance system 101 according to a modification of FIG. 4A.

FIG. 5 is a view illustrating a simulation result of a time required to raise a temperature of a liquid hydrogen pump P to −170 degrees.

FIG. 6A is a schematic configuration view of a maintenance system 102 according to one embodiment.

FIG. 6B is a schematic configuration view of a maintenance system 103 according to a modification of FIG. 6A.

FIG. 7A is a schematic configuration view of a maintenance system 104 according to another embodiment.

FIG. 7B is a schematic configuration view of a maintenance system 105 according to a modification of FIG. 7A.

FIG. 8A is a schematic configuration view of a maintenance system 106 according to still another embodiment.

FIG. 8B is a schematic configuration view of a maintenance system 107 according to a modification of FIG. 8A.

### DESCRIPTION OF EMBODIMENTS

Hereinafter, an embodiment according to the present invention will be specifically described with reference to the drawings.

### First Embodiment

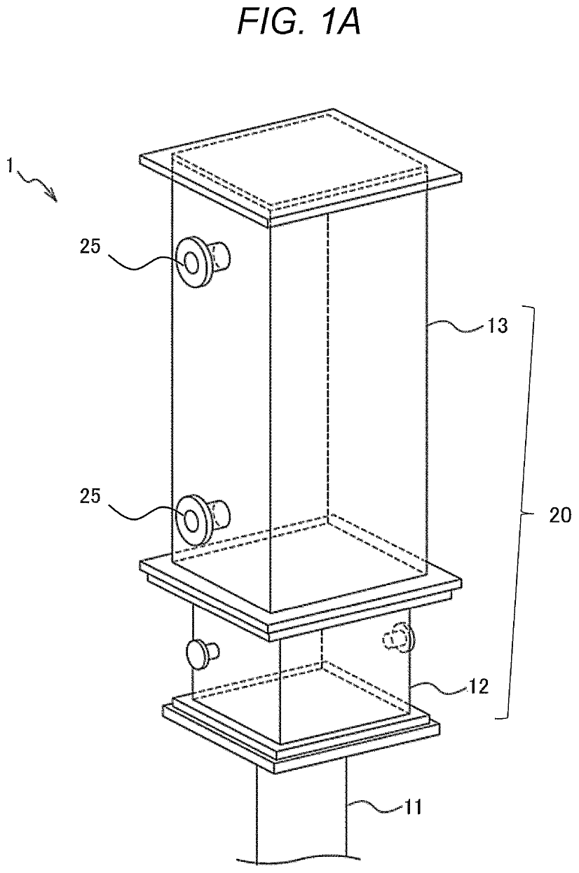

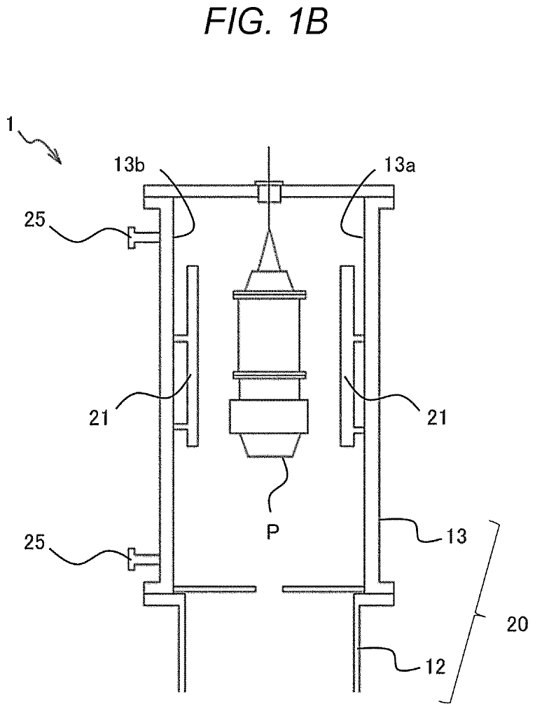

FIGS. 1A and 1B are a partial perspective view and a schematic vertical cross-sectional view of a container system 1 according to a first embodiment, respectively.

The container system 1 is connected to a liquid hydrogen pump P (not illustrated in FIG. 1A) and a hollow column 11 provided around the liquid hydrogen pump P.

In addition, the container system 1 includes a hollow container 20 used for maintenance of the liquid hydrogen pump P. The container 20 includes a hollow buffer container 12 provided on an upper portion of the column 11 and a hollow purge container 13 provided above the column 11 and provided on an upper portion of the buffer container 12.

Normally, the liquid hydrogen pump P is disposed in the column 11. During the maintenance, the container 20 is installed on the column 11, and the liquid hydrogen pump P passes through the column 11 and the container 20 and is pulled out from the upper portion. FIG. 1B illustrates a state in the middle.

As one feature of the present embodiment, heaters 21 are provided on inner surfaces (for example, a set of facing inner surfaces 13a and 13b of the purge container 13) of the container 20. The heater 21 will be described below.

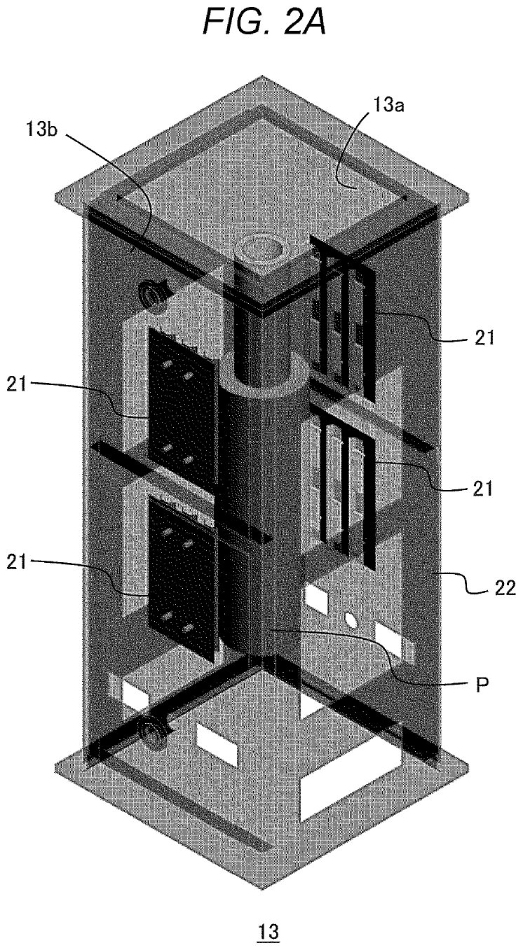

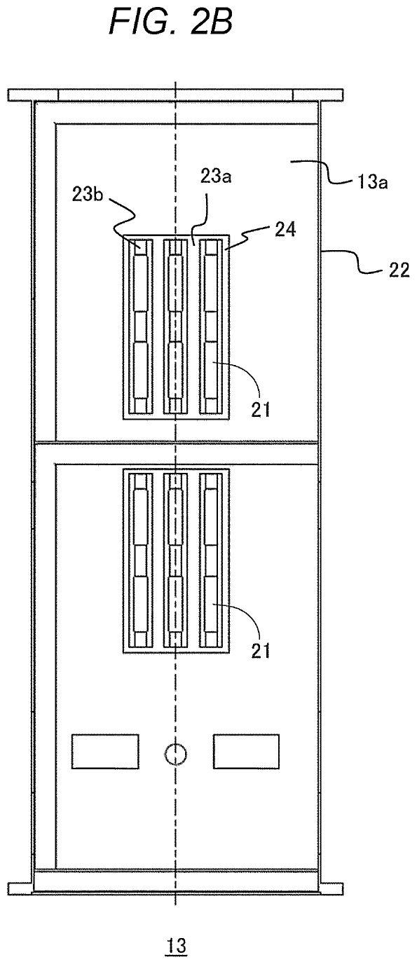

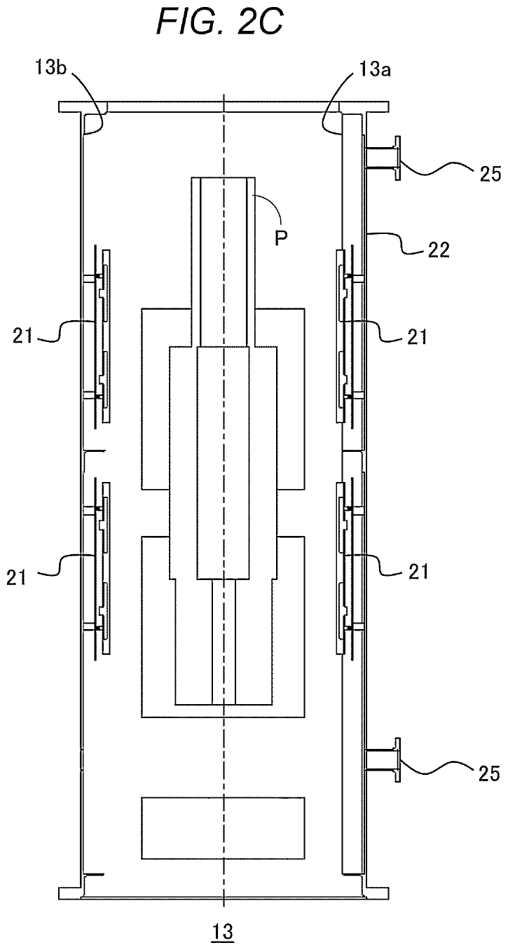

FIG. 2A is a transparent perspective view of the purge container 13 in the container 20 according to the first embodiment. FIG. 2B is a front view of the inner surface 13a of the purge container 13. FIG. 2C is a vertical cross-sectional view passing through centers of the inner surfaces 13a and 13b in the purge container 13.

As a specific configuration example, the purge container 13 has a hollow container main body 22 and heaters 21. The heater 21 is installed on one inner surface 13a of the container main body 22, and the heater 21 is also installed on the facing inner surface 13b. In consideration of the environmental aspect, the heater 21 is desirably a far-infrared ceramic heater that hardly emits sparks. As a result, it is possible to efficiently raise the temperature in a center direction of the purge container 13 by using a radiation heat effect of far infrared rays.

As illustrated in FIG. 2B, it is desirable that reflectors 23a and 23b are provided between the heater 21 and the inner surface 13a. By reflecting heat, it is possible to more efficiently raise the temperature in the center direction in the purge container 13. Furthermore, it is desirable that a coating material 24 for promoting radiation of the far infrared rays is applied to outer surfaces of the reflectors 23a and 23b. Radiation of the far infrared rays from the heater 21 is promoted, and the temperature in the center direction in the purge container 13 can be more efficiently raised.

In addition, a heat sink (not illustrated) may be attached in advance to the liquid hydrogen pump P in a normal temperature state. As a result, the heat of the infrared ray of the heater 21 is more efficiently absorbed by the liquid hydrogen pump P, and the temperature of the liquid hydrogen pump P can be raised in a short time. In addition, the heater 21 (including the reflectors 23a and 23b) may be brought close to the liquid hydrogen pump P only at the time of use and the temperature may be raised in a shorter time as a structure capable of moving the heater.

More specifically, a hinge (not illustrated) is provided at an edge of one end of a plate-shaped heater 21 in a vertical direction (a direction parallel to a central axis of the purge container 13), and the plate-shaped heater 21 is rotatably installed around the edge where the hinge is provided. When the liquid hydrogen pump P is not heated, the entire plate of the heater 21 is disposed in proximity to the inner surfaces 13a and 13b of the purge container, and when the liquid hydrogen pump P is heated, the plate-shaped heater 21 is rotated about the hinge, and the edge without the hinge can be brought close to the liquid hydrogen pump P.

A hand winch (not illustrated) is attached to a wall surface of the purge container, and the plate-shaped heater rotates when a worker externally operates the hand winch. Note that a motor may be rotated by an explosion-proof motor (not illustrated).

An example of a maintenance procedure of the liquid hydrogen pump P using the container 20 is as follows. First, the container 20 is installed on the upper portion of the column 11 provided around the liquid hydrogen pump P. Next, the liquid hydrogen pump P is pulled up in the container 20. At this time, the temperature of the liquid hydrogen pump P in the liquid hydrogen pump P is raised by the heaters 21 provided on the inner surfaces 13a and 13b of the container main body 22. Then, the liquid hydrogen pump P is pulled out from an upper portion of the container main body 22. After the temperature of the liquid hydrogen pump P is raised to about −170 degrees (a temperature higher than a boiling point of nitrogen) in the container main body 22 by the heater 21, the temperature of the liquid hydrogen pump P may be further raised using nitrogen.

Note that it is desirable to purge helium gas into the container main body 22 from pipes 25 (see FIGS. 1A and 1B) provided in the container main body 22. As a result, a downward flow is promoted to a central portion of the container 20 by the cold heat of the liquid hydrogen pump P, and the natural convection is promoted, such that the temperature can be more effectively raised.

As described above, in the first embodiment, the heater 21 is provided in the container 20. Therefore, the temperature of the liquid hydrogen pump P can be raised in a short time, and maintenance can be performed safely.

### Second Embodiment

In the first embodiment described above, the temperature of the liquid hydrogen pump P is raised by the heaters 21. On the other hand, in a second embodiment described below, a pipe through which steam passes is provided to raise the temperature of the liquid hydrogen pump P. Hereinafter, differences from the first embodiment will be mainly described.

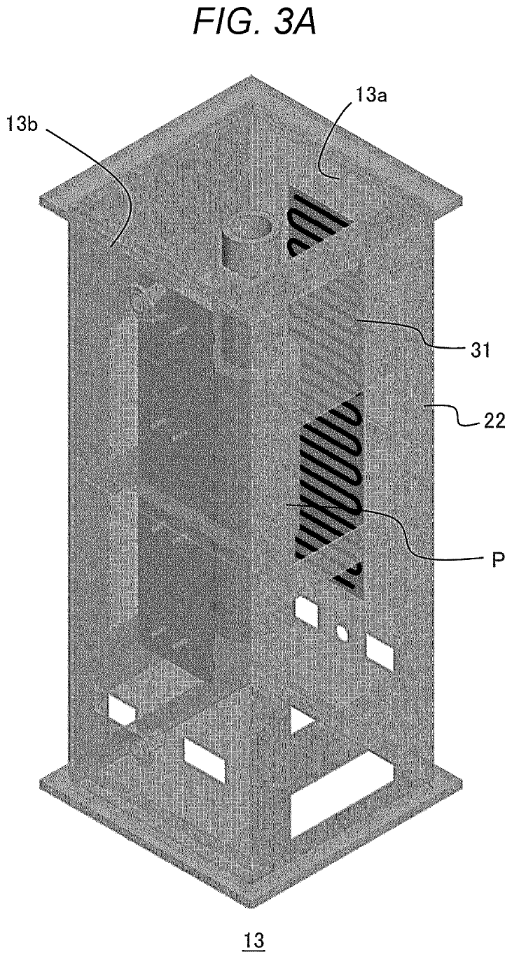

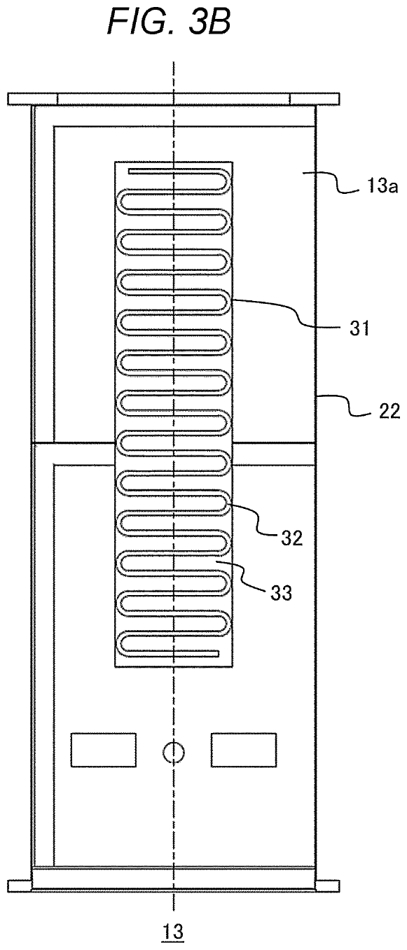

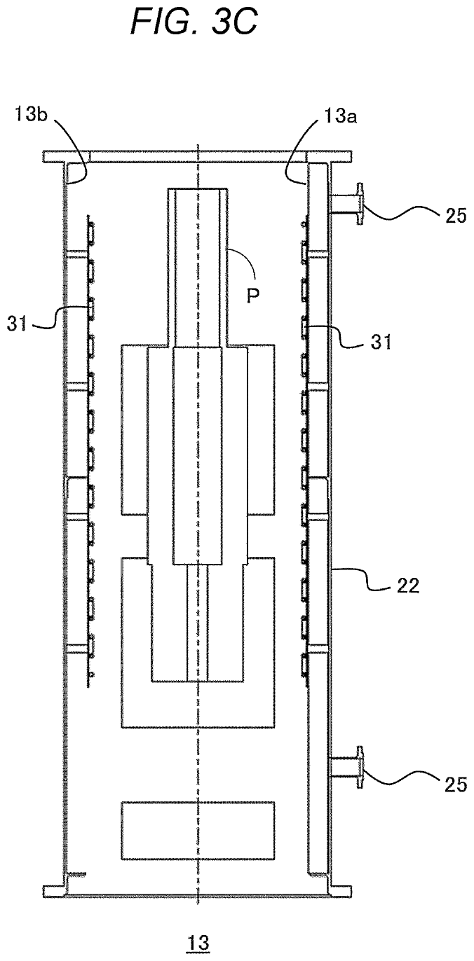

FIG. 3A is a transparent perspective view of the purge container 13 in the container 20 according to the second embodiment. FIG. 3B is a front view of the inner surface 13a of the purge container 13. FIG. 3C is a vertical cross-sectional view passing through the centers of the inner surfaces 13a and 13b in the purge container 13.

In the second embodiment, a pipe (tubing) 31 through which steam (for example, water steam) passes is provided on the inner surface of the container 20. As a specific configuration example, the purge container 13 has a hollow container main body 22 and a pipe 31. The pipe 31 may be installed on one inner surface 13a of the container main body 22, and the pipe 31 may also be installed on the facing inner surface 13b. Steam is allowed to pass through the pipe 31, and the temperature of the liquid hydrogen pump P is raised by using the radiant heat.

As illustrated in FIG. 3B, it is desirable that a reflector 33 is provided between the pipe 31 and the inner surface 13a. By reflecting heat, it is possible to more efficiently raise the temperature in the center direction in the purge container 13. Further, it is desirable that a coating material 32 for promoting radiation of the far infrared rays is applied to outer surfaces of the pipe 31 and the reflector 33. Radiation of the far infrared rays from the pipe 31 is promoted, and the temperature in the center direction in the purge container 13 can be more efficiently raised.

In addition, the pipe 31 (including the reflector 33) may be brought close to the liquid hydrogen pump P only at the time of use and the temperature may be raised in a shorter time as a structure capable of moving the pipe 31. Specifically, although the structure exemplified in the first embodiment is rotatable, it is possible to correspond by connecting the supply pipe to be supplied to the tubing with a flexible pipe (not illustrated). In this case, a pipe connection portion on the tubing side is preferably closer to the hinge in order to shorten a length of the pipe.

An example of a maintenance procedure of the liquid hydrogen pump P using the container 20 is as follows. First, the container 20 is installed on the upper portion of the column 11 provided around the liquid hydrogen pump P. Next, the liquid hydrogen pump P is pulled up in the container 20. At this time, the temperature of the liquid hydrogen in the liquid hydrogen pump P is raised by the far infrared rays caused by the steam passing through the pipes 31 provided on the inner surfaces 13a and 13b of the container main body 22. Then, the liquid hydrogen pump P is pulled out from an upper portion of the container main body 22. After the temperature of the liquid hydrogen in the container main body 22 is raised to about −170 degrees (a temperature higher than the boiling point of nitrogen) by the far infrared rays from the pipe 31, the temperature of the liquid hydrogen pump P may be further raised using nitrogen. In addition, a heat sink (not illustrated) may be attached in advance to the liquid hydrogen pump P in a normal temperature state. As a result, the heat of the infrared ray of the pipe 31 through which the steam passes is more efficiently absorbed by the liquid hydrogen pump P, and the temperature of the liquid hydrogen pump P can be raised in a short time.

Note that it is desirable to purge helium gas into the container main body 22 from pipes 25 (see FIGS. 1A and 1B) provided in the container main body 22. As a result, a downward flow is promoted to a central portion of the container 20 by the cold heat of the liquid hydrogen pump P, and the natural convection is promoted, such that the temperature can be more effectively raised.

As described above, in the second embodiment, the pipe 31 through which steam passes is provided in the container 20. Therefore, the temperature of the liquid hydrogen pump P can be raised in a short time, and maintenance can be performed safely.

### Third Embodiment

In a third and subsequent embodiments, maintenance for raising the temperature of the liquid hydrogen pump P mainly using purge gas (hereinafter, referred to as helium gas) will be described. Hereinafter, differences from the first and second embodiments will be mainly described.

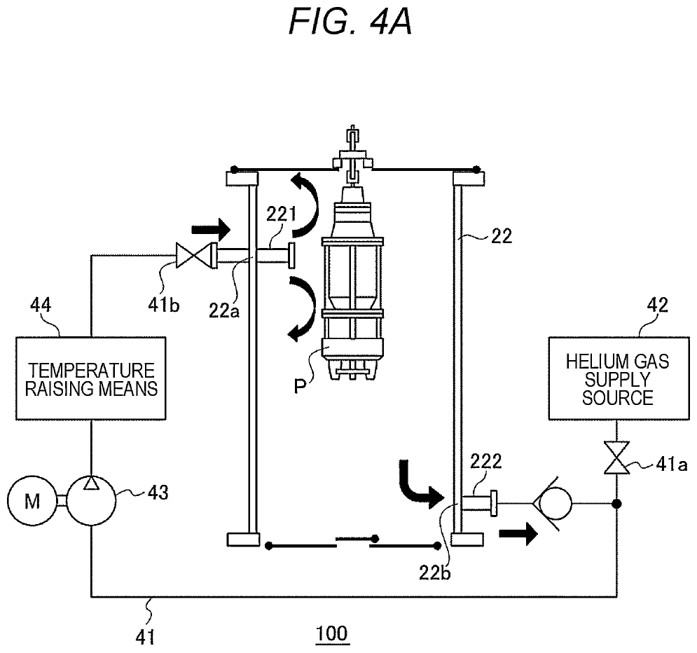

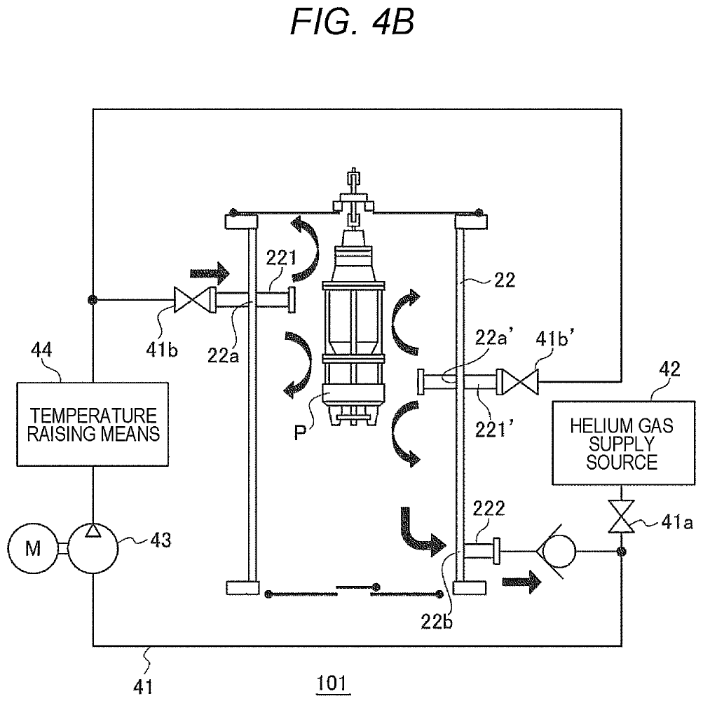

FIG. 4A is a schematic configuration view of a maintenance system 100 according to a third embodiment. The maintenance system 100 includes a container main body 22, a circulation flow path 41, a helium gas supply source 42, a blower 43, and temperature raising means 44.

As in the first and second embodiments described above, the liquid hydrogen pump P can pass through the container main body 22 during maintenance. In the present embodiment, the container main body 22 has one inlet 22a and one outlet 22b.

As a configuration example of the inlet 22a, an inlet nozzle 221 is provided so as to penetrate a side surface of the container main body 22, and one end thereof is outside the container main body 22 and the other end thereof is inside the container main body 22. Desirably, the other end of the inlet nozzle 221 extends in a direction orthogonal to the liquid hydrogen pump P (that is, a horizontal direction), and a tip thereof faces the liquid hydrogen pump P. In other words, the liquid hydrogen pump P is positioned on an extension line of a direction in which the inlet nozzle 221 extends.

As a configuration example of the outlet 22b, an outlet nozzle 222 is provided so as to protrude from the container main body 22. The arrangement position of the outlet 22b is not particularly limited, but it is desirable that the outlet 22b be at a position that does not interfere with the inlet 22a, for example, a lower portion or the like of the container main body 22.

The circulation flow path 41 connects the outlet 22b and the inlet 22a. Specifically, one end of the circulation flow path 41 is connected to the outlet nozzle 222, and the other end is connected to one end of the inlet nozzle 221. Appropriate valves 41a and 41b may be provided on the circulation flow path 41. When the valve 41a is closed, the helium gas supply source 42 is blocked from the circulation flow path 41. When the valve 41b is closed, the inlet 22a is blocked from the circulation flow path 41.

The helium gas supply source 42 is connected to the circulation flow path 41. When the valve 41a is opened, helium gas is supplied to the circulation flow path 41.

The blower 43 (desirably, an explosion-proof blower) is disposed on the circulation flow path 41. Then, the blower 43 sucks a fluid (that is, helium gas) on the outlet 22b side of the container main body 22 and discharges the fluid to the inlet 22a side. As a result, the helium gas circulates in the circulation flow path 41, and the helium gas is guided from the outlet 22b to the inlet 22a.

Specifically, the helium gas supplied from the helium gas supply source 42 to the circulation flow path 41 enters the container main body 22 from the inlet 22a. Then, the helium gas is outputted from the outlet 22b to the circulation flow path 41, and further enters the container main body 22 from the inlet 22a via the circulation flow path 41. In this manner, the helium gas circulates in the circulation flow path 41 and the container main body 22.

The temperature raising means 44 raises the temperature of the helium gas flowing through the circulation flow path 41. Therefore, the helium gas from the outlet 22b enters the container main body 22 from the inlet 22a after being heated. A specific example of the temperature raising means 44 will be described later.

According to such a configuration, the helium gas from the inlet nozzle 221 is blown to a predetermined position of the liquid hydrogen pump P. The temperature of the liquid hydrogen pump P is raised by forced convection heat transfer from the predetermined position. In addition, the temperature of the liquid hydrogen pump P is also raised by in-pipe turbulent flow heat transfer to the entire outer surface of the liquid hydrogen pump P generated in the container main body 22. By circulating the helium gas while raising the temperature, the required amount of helium gas can be saved.

FIG. 4B is a schematic configuration view of a maintenance system 101 according to a modification of FIG. 4A. Hereinafter, differences from FIG. 4A will be mainly described.

In the present modification, the container main body 22 has two inlets 22a and 22a′. The inlet 22a is similar to the inlet 22a of FIG. 4A. Then, an additional inlet 22a′ is provided on a surface of the container main body 22 facing a surface on which the inlet 22a is provided. When a valve 41b′ provided in the circulation flow path 41 is closed, the inlet 22a′ is blocked from the circulation flow path 41.

As a configuration example of the inlet 22a′, an inlet nozzle 221′ is provided so as to penetrate a side surface of the container main body 22, and one end thereof is outside the container main body 22 and the other end thereof is inside the container main body 22. Desirably, the other end of the inlet nozzle 221′ extends in a direction orthogonal to the liquid hydrogen pump P (that is, a horizontal direction), and a tip thereof faces the liquid hydrogen pump P. In other words, the liquid hydrogen pump P is positioned on an extension line of a direction in which the inlet nozzle 221′ extends.

The circulation flow path 41 connects the outlet 22b and the inlets 22a and 22a′. Specifically, one end of the circulation flow path 41 is connected to the outlet nozzle 222, and the other end is bifurcated. One of the branch destinations is connected to one end of the inlet nozzle 221 via the valve 41b, and the other is connected to one end of the inlet nozzle 221′ via the valve 41b′.

A part of the helium gas supplied from the helium gas supply source 42 to the circulation flow path 41 enters the container main body 22 from the inlet 22a, and the other part enters the container main body 22 from the inlet 22a′. Then, the helium gas is outputted from the outlet 22b to the circulation flow path 41, and further enters the container main body 22 from the inlets 22a and 22a′ via the circulation flow path 41. In this manner, the helium gas circulates in the circulation flow path 41 and the container main body 22.

According to such a configuration, the helium gas from the inlet nozzle 221 is blown to a predetermined position of the liquid hydrogen pump P. The helium gas from the inlet nozzle 221′ is blown to another position of the liquid hydrogen pump P. The temperature of the liquid hydrogen pump P is raised by forced convection heat transfer from these positions. That is, an area to which the helium gas is directly blown is larger than that in FIG. 4A (one location in FIG. 4A and two locations in FIG. 4B). In addition, the temperature of the liquid hydrogen pump P is also raised by the in-pipe turbulent flow heat transfer to the entire outer surface of the liquid hydrogen pump P generated in the container main body 22.

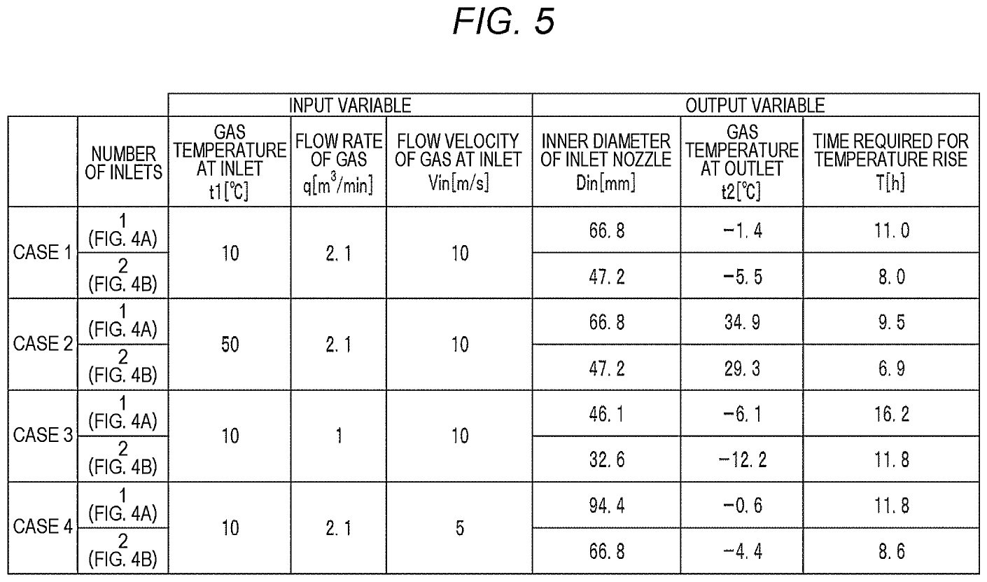

Hereinafter, simulation results of a time required to raise the temperature of the liquid hydrogen pump P to −170 degrees in the maintenance system 100 of FIG. 4A and the maintenance system 101 of FIG. 4B are illustrated in FIG. 5.

In the maintenance system 100 of FIG. 4A, the following input variables were set and the following output variables were calculated.

### [Input Variable]

Gas temperature at inlet 22a: t1 [° C.]
Flow rate of helium gas: q [m³/min]
Flow velocity of helium gas at inlet 22a: Vin [m/s]

### [Output Variable]

Inner diameter of necessary inlet nozzle 221: Din [mm]
Gas temperature at outlet 22b: t2 [° C.]
Time required to raise temperature of liquid hydrogen pump P to −170 degrees: T [h]

In addition, in the maintenance system 101 of FIG. 4B, the following input variables were set and the following output variables were calculated.

### [Input Variable]

Gas temperature at inlets 22a and 22a′: t1 [° C.]
Total flow rate of helium gas: q [m³/min]
(q=flow rate q1 to inlet 22a+flow rate q2 to inlet 22a′)
Flow velocity of helium gas at inlets 22a and 22a′: Vin [m/s]

### [Output Variable]

Inner diameter of necessary inlet nozzles 221 and 221′: Din [mm]
Gas temperature at outlet 22b: t2 [° C.]
Time required to raise temperature of liquid hydrogen pump P to −170 degrees: T [h]

As illustrated in FIG. 5, by appropriately setting the input variables, a time T required for the temperature rise can be made practically sufficiently short.

It should be noted here that, when comparing the maintenance system 100 of FIG. 4A in which one inlet 22a is provided with the maintenance system 101 of FIG. 4B in which two inlets 22a and 22a′ are provided, the latter requires a shorter time T for temperature rise.

For example, in Case 1, t1=10 [° C.], q=2.1 [m³/min], and Vin=10 [m/s] are common, but T=11.0 [h] in the maintenance system 100 of FIG. 4A, whereas T=8.0 [h] in the maintenance system 101 of FIG. 4B, and the time is shortened by about 30%. Even in Cases 2 to 4, although the input variables are common, the time T required for the temperature rise is shorter by about 30% in the maintenance system 101 provided with the two inlets 22a and 22a′.

As described above, even when a temperature and a flow rate of the helium gas are constant, the time required for the temperature rise can be shortened as the number of inlets provided in the container main body 22 increases. In other words, the larger the number of inlets provided in the container main body 22, the smaller the flow rate of the helium gas required for the temperature rise in a predetermined time. The reason is considered as follows.

The main factors that affect the time required for the temperature rise are a heat transfer coefficient, an area of a region to which the helium gas is blown in the liquid hydrogen pump P (hereinafter, simply referred to as “area”), and the temperature of the helium gas to each area (hereinafter, simply referred to as “temperature”). Among them, the heat transfer coefficient depends on a parameter varying depending on the temperature of the helium gas and a flow velocity, and does not depend on the number of inlets. Strictly speaking, when a total flow rate is constant, a flow rate per nozzle decreases and a flow velocity decreases as the number of inlets increases. However, by reducing a nozzle inner diameter, a flow velocity can be kept constant even when the number of inlets is increased. The area is proportional to the number of inlets. The temperature depends only on the temperature raising means and does not depend on the number of inlets.

As the number of inlets increases, the area increases, and an amount of heat given to the pump by the helium gas increases. Therefore, the temperature can be more efficiently raised in FIG. 4B in which two inlets 22a and 22a′ are provided than in FIG. 4A in which one inlet 22a is provided.

This is a new finding obtained by the study of the inventors. From the viewpoint of the efficiency of the temperature rise, it is more desirable as the number of inlets is larger, but in practice, it is only required to determine an appropriate number of inlets in consideration of the size of the container main body 22, the inner diameter of the inlet nozzle 221, and the like. The position of the liquid hydrogen pump P to which the helium gas is blown is not necessarily the side surface, and may be any position.

Hereinafter, a specific configuration of the temperature raising means 44 will be exemplified.

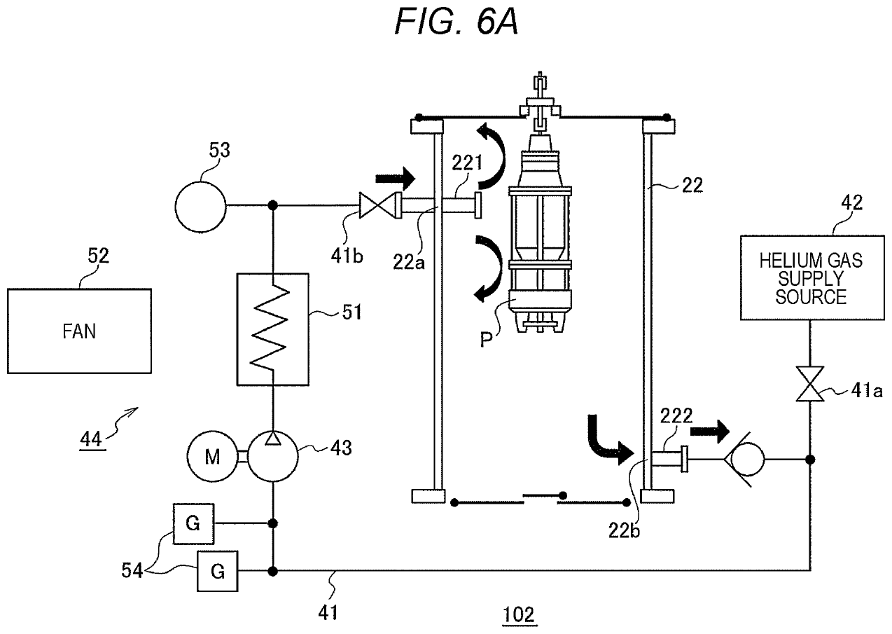

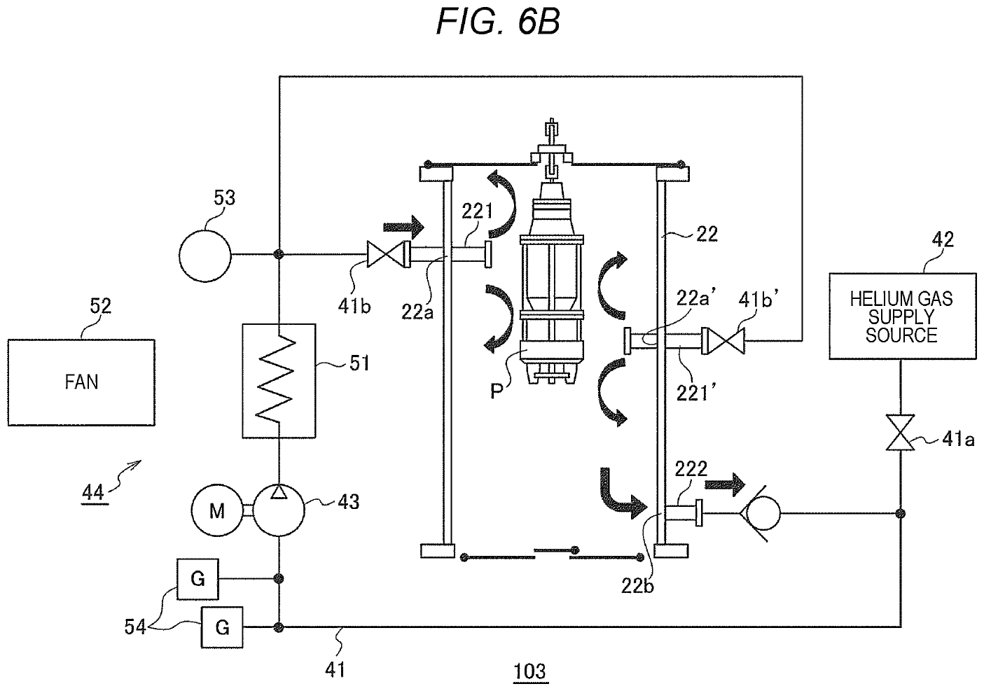

FIG. 6A is a schematic configuration view of a maintenance system 102 according to one embodiment. The maintenance system 102 includes a heat exchanger 51 and a fan 52 as the temperature raising means 44 in the maintenance system 100 of FIG. 4A.

The heat exchanger 51 raises the temperature of the helium gas passing through the circulation flow path 41 by the atmosphere. That is, the heat exchanger 51 is installed at a position where the temperature of the helium gas passing through the circulation flow path 41 can be raised. As the heat exchanger 51, for example, a fin-tube heat exchanger or an elofin heat exchanger can be applied. The heat exchanger 51 may be disposed on an upstream side of the blower 43 or may be disposed on a downstream side of the blower 43.

The fan 52 (desirably, an explosion-proof fan) sends, for example, wind of about 10 degrees to the heat exchanger 51. As a result, heat exchange of the helium gas by the heat exchanger 51 is promoted. By providing the fan 52, the influence of an air temperature and an air volume of the atmosphere can be suppressed.

In addition, a temperature sensor 53 may be provided on a downstream side of the heat exchanger 51 in the circulation flow path 41 (in the vicinity of the inlet 22a) to measure the temperature of the helium gas entering the container main body 22. In addition, gas detectors 54 may be provided in the circulation flow path 41 such that it can be confirmed that the hydrogen gas does not leak from the liquid hydrogen pump P or the column 11.

FIG. 6B is a schematic configuration view of a maintenance system 103 according to a modification of FIG. 6A. As shown in the drawing, in the maintenance system 102 shown in FIG. 6A, two inlets 22a and 22a′ may be provided (see FIG. 4B).

The procedure of maintenance by the above maintenance systems 102 and 103 is as follows. First, the container 20 including the hollow container main body 22 having one or more inlets 22a and one outlet 22b is installed on the upper portion of the hollow column 11 provided around the liquid hydrogen pump P. Then, by circulating the helium gas through the circulation flow path 41 connecting the outlet 22b and the one or more inlets 22a and the container main body 22 while pulling up the liquid hydrogen pump P in the container 20, the temperature of the liquid hydrogen pump P in the container main body 22 is raised, and the temperature of the helium gas passing through the circulation flow path 41 is raised by the atmosphere by the heat exchanger 51.

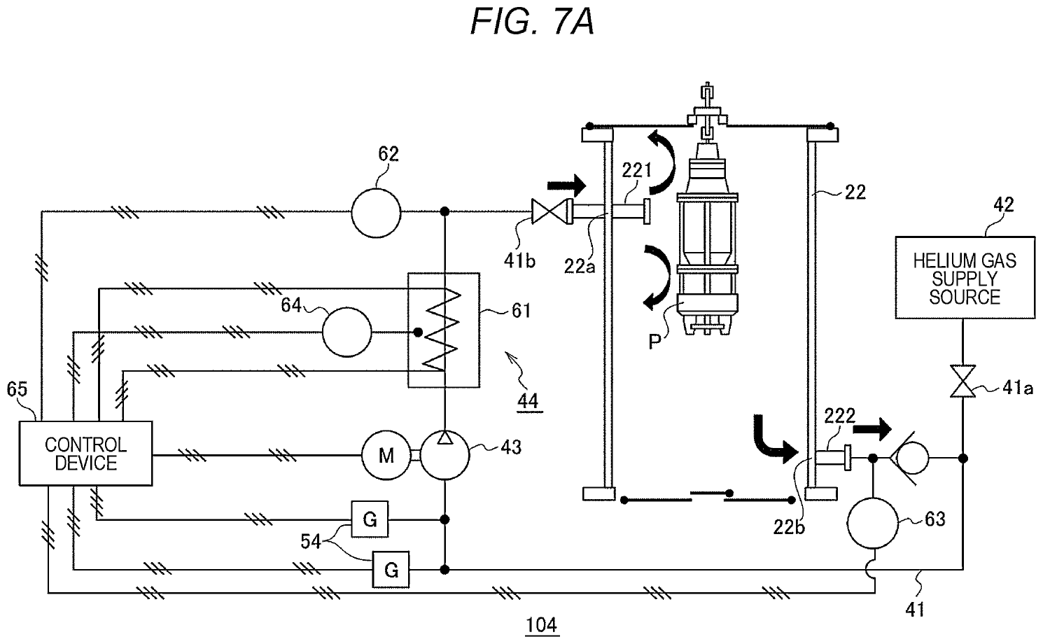

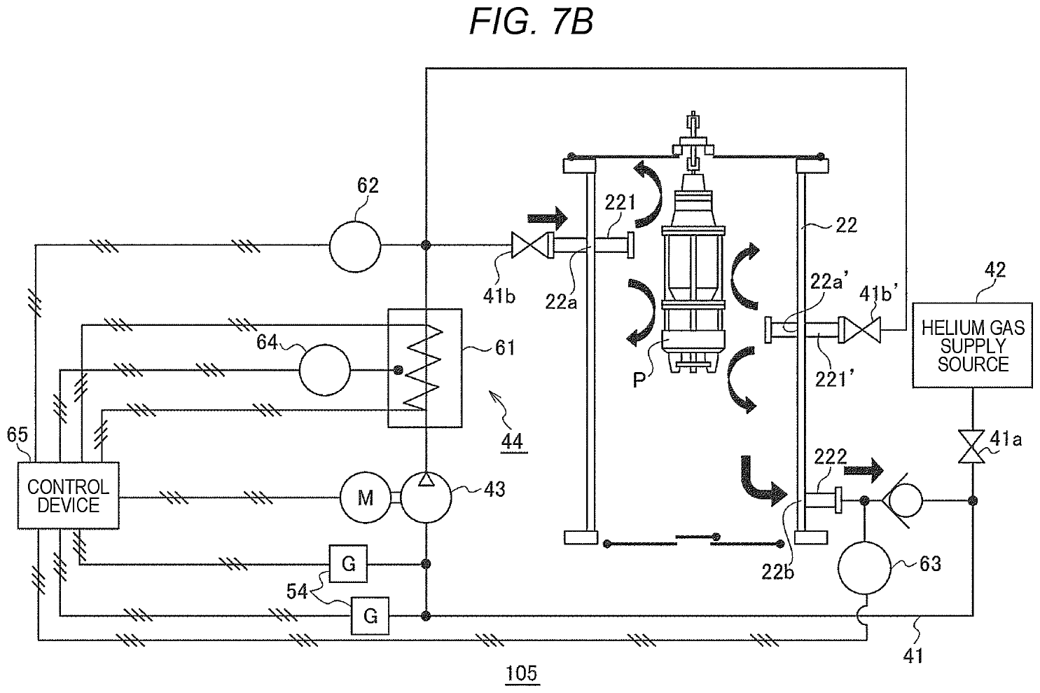

FIG. 7A is a schematic configuration view of a maintenance system 104 according to another embodiment. The maintenance system 104 includes an electric heater 61 as the temperature raising means 44 in the maintenance system 100 of FIG. 4A, and further includes temperature sensors 62 to 64 and a control device 65.

The electric heater 61 raises the temperature of the helium gas passing through the circulation flow path 41. That is, the electric heater 61 is installed at a position where the temperature of the helium gas passing through the circulation flow path 41 can be raised. For safety and legal reasons, it is desirable that the electric heater 61 does not come into contact with the helium gas, and it is desirable that the electric heater 61 does not come into contact with the hydrogen gas even when the hydrogen gas leaks into the circulation flow path 41. As a specific example, the electric heater 61 is disposed around the pipe constituting the circulation flow path 41. The electric heater 61 raises the temperature of helium gas in the pipe by raising the temperature of the pipe. As such an electric heater 61, for example, a square coil heater can be applied. The electric heater 61 may be disposed on the upstream side of the blower 43 or may be disposed on the downstream side of the blower 43.

The temperature sensor 62 is provided, for example, on a downstream side of the electric heater 61 in the circulation flow path 41 (in the vicinity of the inlet 22a), and measures a temperature t1 of the helium gas entering the container main body 22. The measured temperature t1 of the helium gas is transmitted to the control device 65.

The temperature sensor 63 is provided, for example, on an upstream side of the electric heater 61 (in the vicinity of the outlet 22b) in the circulation flow path 41, and measures a temperature t2 of the helium gas outputted from the container main body 22. The measured temperature t2 of the helium gas is transmitted to the control device 65. The temperature t2 reflects the temperature of the liquid hydrogen pump P. The higher the temperature of the liquid hydrogen pump P, the higher the temperature t2.

The temperature sensor 64 is provided, for example, in the vicinity of the electric heater 61, and measures a surface temperature t3 of the electric heater 61. The measured surface temperature t3 is transmitted to the control device 65.

The control device 65 may control the temperature rise of the helium gas by the electric heater 61 or a flow rate of the helium gas by the blower 43 based on the temperatures t1 and t2 of the helium gas.

That is, when the temperature of the liquid hydrogen pump P rises, a difference between the temperature t1 of the helium gas entering the container main body 22 and the temperature of the liquid hydrogen pump P decreases, and the temperature rise efficiency decreases. Therefore, the control device 65 controls the electric heater 61 such that the temperature t1 of the helium gas entering the container main body 22 increases as the temperature of the liquid hydrogen pump P increases. Alternatively, the control device 65 controls the blower 43 such that a flow rate of the helium gas entering the container main body 22 increases.

Here, the temperature of the liquid hydrogen pump P may be measured, but it is convenient to use the fact that the temperature t2 of the helium gas outputted from the container main body 22 increases as the temperature of the liquid hydrogen pump P increases. As a specific example, by setting a difference between the temperature t1 and the temperature t2 to a constant value, the temperature t1 of the helium gas entering the container main body 22 can be increased as the temperature of the liquid hydrogen pump P rises. Therefore, the control device 65 preferably controls the electric heater 61 such that the difference between the temperature t1 and the temperature t2 becomes a constant value.

For example, when the temperature t2 increases (that is, the temperature of the liquid hydrogen pump P increases) and the difference between the temperature t1 and the temperature t2 decreases, the control device 65 increases a current flowing through the electric heater 61. As a result, the electric heater 61 further increases the temperature of the helium gas flowing through the circulation flow path 41, and the temperature t1 of the helium gas entering the container main body 22 increases. In this manner, the difference between the temperature t1 and the temperature t2 can be maintained at a constant value.

As another example, when the blower 43 is inverter-controllable, in a case where the difference between the temperature t1 and the temperature t2 decreases, the control device 65 increases the flow rate of the helium gas by increasing a rotation speed of the blower 43. As a result, a flow velocity of the helium gas increases, and a heat transfer coefficient increases. In this manner, an amount of heat given to the liquid hydrogen pump P by purge gas can be maintained at a constant value. Specifically, the control device 65 can calculate the amount of heat given to the liquid hydrogen pump P by the helium gas based on the difference between the temperature t1 and the temperature t2, and control the flow rate of the helium gas by the blower 43 such that the amount of heat given to the liquid hydrogen pump P by the helium gas becomes constant. In this case, the blower 43 also functions as the temperature raising means 44.

In addition, the control device 65 may control the temperature rise of the helium gas by the electric heater 61 based on the surface temperature t3 of the electric heater 61 in order to suppress overheating of the electric heater 61. For example, when the surface temperature t3 of the electric heater 61 is equal to or higher than a threshold value, the control device 65 may reduce an amount of current flowing through the electric heater 61 or may stop an operation of the electric heater 61. This further improves the safety.

FIG. 7B is a schematic configuration view of a maintenance system 105 according to a modification of FIG. 7A. As shown in the drawing, in the maintenance system 104 shown in FIG. 7A, two inlets 22a and 22a′ may be provided (see FIG. 4B).

The procedure of maintenance by the above maintenance systems 104 and 105 is as follows. First, the container 20 including the hollow container main body 22 having one or more inlets 22a and one outlet 22b is installed on the upper portion of the hollow column 11 provided around the liquid hydrogen pump P. Then, by circulating the helium gas through the circulation flow path 41 connecting the outlet 22b and the one or more inlets 22a and the container main body 22 while pulling up the liquid hydrogen pump P in the container 20, the temperature of the liquid hydrogen pump P in the container main body 22 is raised, and the temperature of the helium gas passing through the circulation flow path 41 is raised by the electric heater 61.

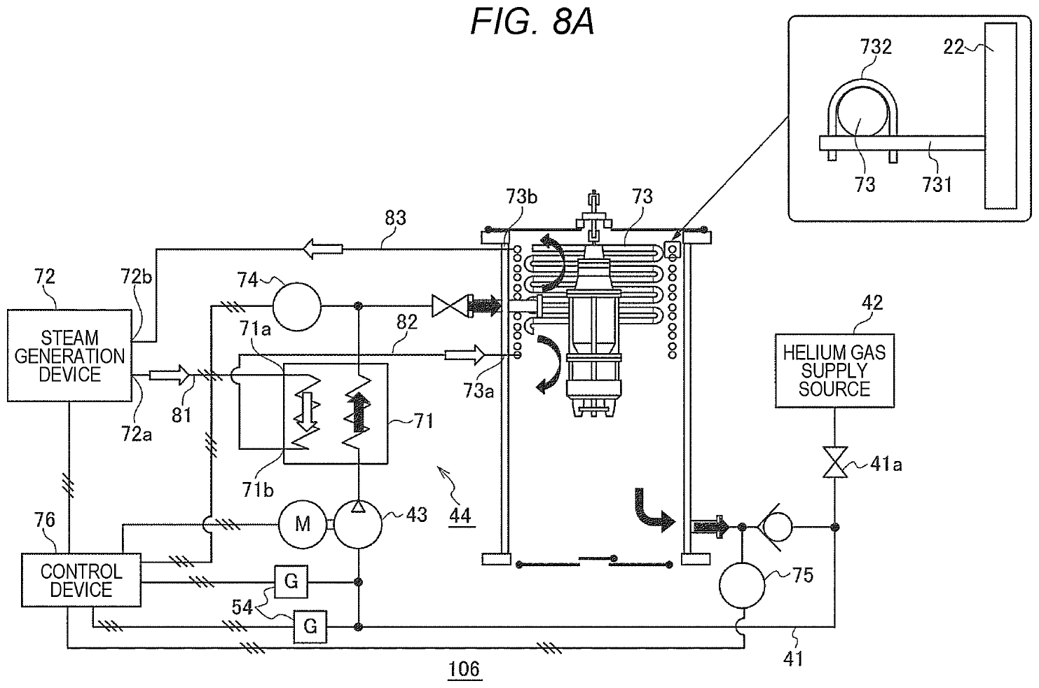

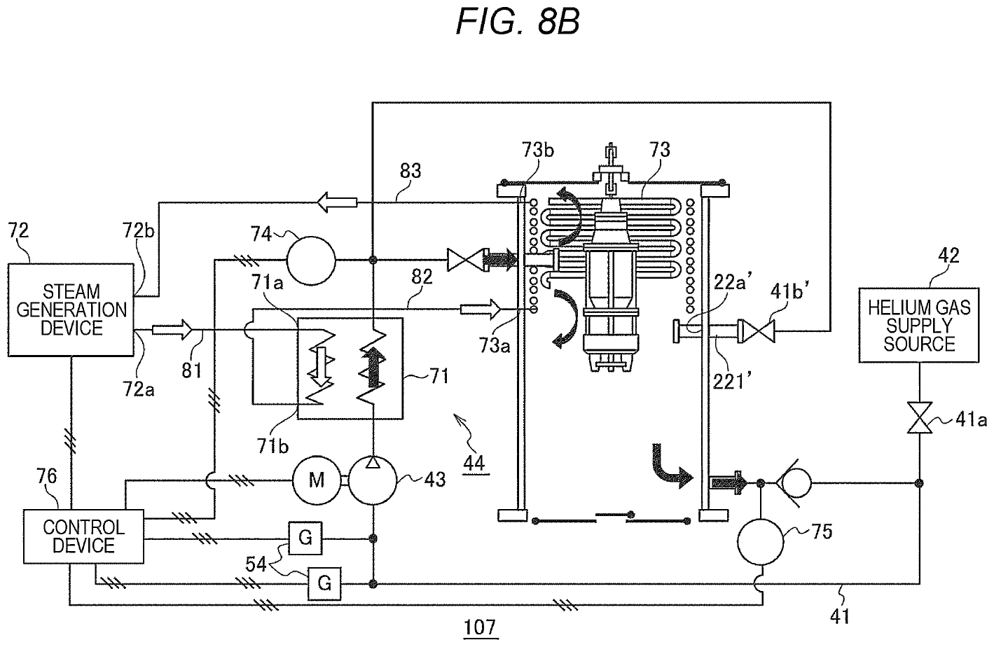

FIG. 8A is a schematic configuration view of a maintenance system 106 according to still another embodiment. The maintenance system 106 includes a heat exchanger 71 and a steam generation device 72 as the temperature raising means 44 in the maintenance system 100 of FIG. 4A, and further includes a steam pipe 73, temperature sensors 74 and 75, and a control device 76.

The heat exchanger 71 raises the temperature of the helium gas passing through the circulation flow path 41 by steam from the steam generation device 72. That is, the heat exchanger 71 is installed at a position where the temperature of the helium gas passing through the circulation flow path 41 can be raised. As the heat exchanger 71, for example, a plate-type heat exchanger or a tube-type heat exchanger can be applied. The heat exchanger 71 may be disposed on the upstream side of the blower 43 or may be disposed on the downstream side of the blower 43.

The steam pipe 73 is provided in the container main body 22 (see the second embodiment). As an example, the steam pipe 73 may be fixed to a flat steel 731 having one end fixed to an inner surface of the container main body 22 using a U-bolt 732. As a result, a heat transfer route is only the flat steel 731, and the container main body 22 is hardly affected by the heat by the steam pipe 73. When the steam from the steam generation device 72 passes through the steam pipe 73, the temperature of the liquid hydrogen pump P in the container main body 22 is raised.

The steam generation device 72 supplies steam to the heat exchanger 71 and the steam pipe 73. As an example, a steam outlet 72a of the steam generation device 72 and a steam inlet 71a of the heat exchanger 71 are connected by a pipe 81. A steam outlet 71b of the heat exchanger 71 and a steam inlet 73a of the steam pipe 73 are connected by a pipe 82. A steam outlet 73b of the steam pipe 73 and a steam inlet 72b of the steam generation device 72 are connected by a pipe 83.

The steam outputted from the steam generation device 72 enters the heat exchanger 71 via the pipe 81. The steam outputted from the heat exchanger 71 enters the steam pipe 73 via the pipe 82. The steam outputted from the steam pipe 73 enters the steam generation device 72 via the pipe 83. As described above, it is desirable that the steam circulates through the heat exchanger 71 and the steam pipe 73 in one loop without branching from the steam outlet 72a to the steam inlet 72b of the steam generation device 72. As a result, the steam from the steam generation device 72 can be used for both the heat exchanger 71 and the steam pipe 73, and the device configuration can be simplified.

The temperature sensor 74 is provided, for example, on a downstream side of the heat exchanger 71 in the circulation flow path 41 (in the vicinity of the inlet 22a), and measures a temperature t1 of the helium gas entering the container main body 22. The measured temperature t1 of the helium gas is transmitted to the control device 76.

The temperature sensor 75 is provided, for example, on an upstream side of the heat exchanger 71 (in the vicinity of the outlet 22b) in the circulation flow path 41, and measures a temperature t2 of the helium gas outputted from the container main body 22. The measured temperature t2 of the helium gas is transmitted to the control device 76. The temperature t2 reflects the temperature of the liquid hydrogen pump P. The higher the temperature of the liquid hydrogen pump P, the higher the temperature t2.

The control device 76 may control steam supply by the steam generation device 72 or may control a flow rate of the helium gas by the blower 43 based on the temperatures t1 and t2 of the helium gas.

That is, when the temperature of the liquid hydrogen pump P rises, a difference between the temperature t1 of the helium gas entering the container main body 22 and the temperature of the liquid hydrogen pump P decreases, and the temperature rise efficiency decreases. Therefore, the control device 76 controls the steam generation device 72 such that the temperature t1 of the helium gas entering the container main body 22 increases as the temperature of the liquid hydrogen pump P increases. Alternatively, the control device 65 controls the blower 43 such that a flow rate of the helium gas entering the container main body 22 increases.

Here, the temperature of the liquid hydrogen pump P may be measured, but it is convenient to use the fact that the temperature t2 of the helium gas outputted from the container main body 22 increases as the temperature of the liquid hydrogen pump P increases. As a specific example, by setting a difference between the temperature t1 and the temperature t2 to a constant value, the temperature t1 of the helium gas entering the container main body 22 can be increased as the temperature of the liquid hydrogen pump P rises. Therefore, it is preferable that the control device 76 controls the steam generation device 72 such that an amount of heat given to the liquid hydrogen pump P by the helium gas becomes a constant value based on the difference between the temperature t1 and the temperature t2.

For example, when the temperature t2 increases (that is, the temperature of the liquid hydrogen pump P increases) and the difference between the temperature t1 and the temperature t2 decreases, the control device 76 increases the temperature of the steam supplied from the steam generation device 72 to the heat exchanger 71 and/or increases the flow rate of the steam. As a result, the heat exchanger 71 further increases the temperature of the helium gas flowing through the circulation flow path 41, and the temperature t1 of the helium gas entering the container main body 22 increases. In this manner, the difference between the temperature t1 and the temperature t2 can be maintained at a constant value.

Note that the control device 76 may control the temperature of the steam outputted from the steam generation device 72 or may control the flow rate, but it is more desirable to control the flow rate. This is because the steam is supplied not only to the heat exchanger 71 but also to the steam pipe 73 in the container main body 22, but there is an upper limit to the temperature of the steam that can be supplied to the steam pipe 73.

As another example, when the blower 43 is inverter-controllable, in a case where the difference between the temperature t1 and the temperature t2 decreases, the control device 76 increases the flow rate of the helium gas by increasing a rotation speed of the blower 43. As a result, a flow velocity of the helium gas increases, and a heat transfer coefficient increases. In this manner, an amount of heat given to the liquid hydrogen pump P by purge gas can be maintained at a constant value. Specifically, the control device 65 can calculate the amount of heat given to the liquid hydrogen pump P by the helium gas based on the difference between the temperature t1 and the temperature t2, and control the flow rate of the helium gas by the blower 43 such that the amount of heat given to the liquid hydrogen pump P by the helium gas becomes constant. In this case, the blower 43 also functions as the temperature raising means 44.

FIG. 8B is a schematic configuration view of a maintenance system 107 according to a modification of FIG. 8A. As shown in the drawing, in the maintenance system 106 shown in FIG. 8A, two inlets 22a and 22a′ may be provided (see FIG. 4B).

The procedure of maintenance by the above maintenance systems 106 and 107 is as follows. First, the container 20 including the hollow container main body 22 having one or more inlets 22a and one outlet 22b and provided with the steam pipe 73 on the inner surface is installed on the upper portion of the hollow column 11 provided around the liquid hydrogen pump P. Then, by circulating the helium gas through the circulation flow path 41 connecting the outlet 22b and the one or more inlets 22a and the container main body 22 while pulling up the liquid hydrogen pump P in the container 20, and passing steam from the steam generation device 72 through the steam pipe 73, the temperature of the liquid hydrogen pump P in the container main body 22 is raised, and the temperature of the helium gas passing through the circulation flow path 41 is raised by the steam from the steam generation device 72 by the heat exchanger 71.

As described above, the present invention is not limited to the above-described embodiments as it is, and can be embodied by modifying the constituent elements without departing from the gist of the present invention in the implementation stage. In addition, various inventions can be formed by appropriately combining a plurality of constituent elements disclosed in the above embodiments. For example, some constituent elements may be deleted from all the constituent elements shown in the embodiments. Furthermore, constituent elements in different embodiments may be appropriately combined.

### REFERENCE SIGNS LIST

P Liquid hydrogen pump
1 Container system
11 Column
12 Buffer container
13 Purge container
13a, 13b Inner surface
20 Container
21 Heater
22 Container main body
221, 221′ Inlet nozzle
222 Outlet nozzle
22a, 22a′ Inlet
22b Outlet
23a, 23b, 33 Reflector
24, 32 Coating material that promotes radiation of far infrared rays
31 Pipe
41 Circulation flow path
41a, 41b Valve
42 Helium gas supply source
43 Blower
44 Temperature raising means
51 Heat exchanger
52 Fan
53 Temperature sensor
54 Gas detector
61 Electric heater
62 to 64 Temperature sensor
65 Control device
71 Heat exchanger
71a Steam inlet
72b Steam outlet
72 Steam generation device
72a Steam outlet
72b Steam inlet
73 Steam pipe
731 Flat steel
732 U-bolt
73a Steam inlet
73b Steam outlet
74, 75 Temperature sensor
76 Control device
81 to 83 Pipe

What is claimed is:

1. A maintenance system used for maintenance of a liquid hydrogen pump, the maintenance system comprising:
a hollow container main body that allows a liquid hydrogen pump to pass through during maintenance, the container main body having one or more inlets and one outlet;
a circulation flow path that connects the outlet and the one or more inlets;
a blower that is provided on the circulation flow path and guides helium gas from the outlet to the one or more inlets to circulate the helium gas in the circulation flow path; and
a heat exchanger that raises a temperature of the helium gas passing through the circulation flow path by atmosphere.

2. The maintenance system according to claim 1, further comprising a fan that blows air to the heat exchanger.

3. A maintenance system used for maintenance of a liquid hydrogen pump, the maintenance system comprising:
a hollow container main body that allows a liquid hydrogen pump to pass through during maintenance, the container main body having one or more inlets and one outlet;
a circulation flow path that connects the outlet and the one or more inlets;
a blower that is provided on the circulation flow path and guides helium gas from the outlet to the one or more inlets to circulate the helium gas in the circulation flow path; and
an electric heater that raises a temperature of the helium gas passing through the circulation flow path.

4. The maintenance system according to claim 3, wherein the electric heater is provided around a pipe constituting the circulation flow path and is not in contact with helium gas.

5. The maintenance system according to claim 3, further comprising:
a first temperature sensor that is provided in the circulation flow path and measures a first temperature of helium gas to the container main body;
a second temperature sensor that is provided in the circulation flow path and measures a second temperature of helium gas from the container main body; and
a controller that controls temperature rise by the electric heater based on the first temperature and the second temperature.

6. The maintenance system according to claim 5, wherein the controller controls the temperature rise by the electric heater such that a difference between the first temperature and the second temperature becomes constant.

7. The maintenance system according to claim 3, further comprising:
a first temperature sensor that is provided in the circulation flow path and measures a first temperature of helium gas to the container main body;
a second temperature sensor that is provided in the circulation flow path and measures a second temperature of helium gas from the container main body; and
a controller that controls a flow rate of helium gas generated by the blower based on the first temperature and the second temperature.

8. The maintenance system according to claim 7, wherein the controller controls the flow rate of helium gas by the blower based on a difference between the first temperature and the second temperature such that an amount of heat given by helium gas to the liquid hydrogen pump becomes constant.

9. The maintenance system according to claim 3, further comprising:
a third sensor that measures a third temperature of the electric heater; and
a controller that controls temperature rise by the electric heater based on the third temperature.

10. A maintenance system used for maintenance of a liquid hydrogen pump, the maintenance system comprising:
a hollow container main body that allows a liquid hydrogen pump to pass through during maintenance, the container main body having one or more inlets and one outlet;
a circulation flow path that connects the outlet and the one or more inlets;
a blower that is provided on the circulation flow path and guides helium gas from the outlet to the one or more inlets to circulate the helium gas in the circulation flow path;
a heat exchanger that raises a temperature of the helium gas passing through the circulation flow path by steam;
a steam pipe that is provided on an inner surface of the container main body and through which steam passes; and
a steam generation device that supplies steam to the heat exchanger and the steam pipe.

11. The maintenance system according to claim 10, further comprising:
a first pipe that connects a steam outlet of the steam generation device and a steam inlet of the heat exchanger;
a second pipe that connects a steam outlet of the heat exchanger and a steam inlet of the steam pipe; and
a third pipe that connects a steam outlet of the steam pipe and a steam inlet of the steam generation device.

12. The maintenance system according to claim 10, further comprising:
a first temperature sensor that is provided in the circulation flow path and measures a first temperature of helium gas to the container main body;
a second temperature sensor that is provided in the circulation flow path and measures a second temperature of helium gas from the container main body; and
a controller that controls supply of steam from the steam generation device based on the first temperature and the second temperature.

13. The maintenance system according to claim 12, wherein the controller controls a flow rate of the steam from the steam generation device based on a difference between the first temperature and the second temperature such that an amount of heat given to the liquid hydrogen pump by helium gas is constant.

14. The maintenance system according to claim 10, further comprising:
a first temperature sensor that is provided in the circulation flow path and measures a first temperature of helium gas to the container main body;
a second temperature sensor that is provided in the circulation flow path and measures a second temperature of helium gas from the container main body; and
a controller that controls a flow rate of helium gas generated by the blower based on the first temperature and the second temperature.

15. The maintenance system according to claim 14, wherein the controller controls a flow rate of the helium gas by the blower based on a difference between the first temperature and the second temperature such that an amount of heat given to the liquid hydrogen pump by helium gas becomes constant.

16. The maintenance system according to claim 1, wherein the one or more inlets include at least a first inlet and a second inlet.

17. The maintenance system according to claim 16, wherein
helium gas from the first inlet is directly blown to a first portion of the liquid hydrogen pump, and
helium gas from the second inlet is directly blown to a second portion of the liquid hydrogen pump different from the first portion.

18. A maintenance method for a liquid hydrogen pump, comprising:
a step of installing a container including a hollow container main body having one or more inlets and one outlet on an upper portion of a hollow column provided around the liquid hydrogen pump;
a step of raising a temperature of the liquid hydrogen pump in the container main body by circulating helium gas in a circulation flow path connecting the outlet and the one or more inlets and the container main body while pulling up the liquid hydrogen pump in the container; and
a step of raising, by a heat exchanger, a temperature of the helium gas passing through the circulation flow path by atmosphere.

19. A maintenance method for a liquid hydrogen pump, comprising:
a step of installing a container including a hollow container main body having one or more inlets and one outlet on an upper portion of a hollow column provided around the liquid hydrogen pump;
a step of raising a temperature of the liquid hydrogen pump in the container main body by circulating helium gas in a circulation flow path connecting the outlet and the one or more inlets and the container main body while pulling up the liquid hydrogen pump in the container; and
a step of raising, by an electric heater, a temperature of the helium gas passing through the circulation flow path.

20. A maintenance method for a liquid hydrogen pump, comprising:
a step of installing a container including a hollow container main body having one or more inlets and one outlet and provided with a steam pipe on an inner surface, on an upper portion of a hollow column provided around the liquid hydrogen pump;
a step of raising a temperature of the liquid hydrogen pump in the container main body by circulating helium gas in a circulation flow path connecting the outlet and the one or more inlets and the container main body, and allowing steam from a steam generation device to pass through the steam pipe while pulling up the liquid hydrogen pump in the container; and
a step of, by a heat exchanger, raising a temperature of the helium gas passing through the circulation flow path by the steam from the steam generation device.

21. A container used for maintenance of a liquid hydrogen pump, the container comprising:
a hollow container main body that allows a liquid hydrogen pump to pass through during maintenance; and
a heater provided on an inner surface of the container main body.

22. The container according to claim 21, wherein the heater is a far-infrared ceramic heater.

23. A container used for maintenance of a liquid hydrogen pump, the container comprising:
a hollow container main body that allows a liquid hydrogen pump to pass through during maintenance; and
a pipe that is provided on an inner surface of the container main body and through which steam passes.

24. The container according to claim 23, wherein a coating material that promotes radiation of far infrared rays is applied to an outer surface of the pipe.

25. The container according to claim 21, wherein the container main body is provided with a pipe used for purging helium gas.

26. A container system comprising:
a liquid hydrogen pump;
a hollow column provided around the liquid hydrogen pump; and
the container according to claim 21 installed on an upper portion of the hollow column.

27. A maintenance method for a liquid hydrogen pump, comprising:
a step of installing a hollow container provided with a heater on an inner surface, on an upper portion of a hollow column provided around the liquid hydrogen pump; and
a step of pulling up the liquid hydrogen pump in the container and raising a temperature of the liquid hydrogen pump by the heater.

28. A maintenance method for a liquid hydrogen pump, comprising:
a step of installing a hollow container provided with a pipe through which steam passes on an inner surface, on an upper portion of a hollow column provided around the liquid hydrogen pump; and
a step of pulling up the liquid hydrogen pump in the container and raising a temperature of the liquid hydrogen pump by far infrared rays caused by the steam.

29. The maintenance method for a liquid hydrogen pump according to claim 27, further comprising a step of purging helium gas inside the container.

30. The maintenance method for a liquid hydrogen pump according to claim 27, further comprising a step of further raising the temperature of the liquid hydrogen pump, which has been raised, using nitrogen.
